(19) United States
(12) Patent Application Publication
(10) Pub. No.: US 2010/0166961 A1
(43) Pub. Date: Jul. 1, 2010

(54) PRODUCTION OF HIGH POROSITY OPEN-CELL MEMBRANES

(76) Inventor: Kirby W. Beard, Norristown, PA (US)

Correspondence Address: BLACK LOWE & GRAHAM, PLLC, 701 FIFTH AVENUE, SUITE 4800, SEATTLE, WA, 98104, US

(21) Appl. No.: 12/537,218

(22) Filed: Aug. 6, 2009

Related U.S. Application Data
(63) Continuation-in-part of application No. 11/634,499, filed on Dec. 6, 2006, now abandoned.
Application No. 11/634,499 is a continuation of application No. 11/040,227, filed on Jan. 21, 2005, now abandoned.
(60) Provisional application No. 60/537,005, filed on Jan. 20, 2004.

(51) Int. Cl. B29C 44/22

(52) U.S. Cl. 427/256

(57) ABSTRACT

A method for forming an open celled membrane. A gelled polymer is formed of a polymer having a known polymer interfacial tension and a known polymer melting point. A first liquid into which the polymer is soluble, the first liquid being selected to have a first liquid interfacial tension to be 95% or less than the polymer interfacial tension is mixed with a second liquid that is miscible in the first liquid to form a mixture. The second liquid is selected to have a second liquid interfacial tension to be 105% or greater than the polymer interfacial tension. The polymer is dissolved into the mixture to form a saturated solution. The saturated solution reaches a solution forming temperature which is less than the polymer melting point. The saturated solution is spread on a substrate. The first liquid from the saturated solution to form the gelled polymer.

### PRIORITY CLAIM

This application is a continuation-in-part of U.S. patent application Ser. No. 11/634,499 filed on Dec. 6, 2006, which, itself, is a continuation-in-part of U.S. patent application Ser. No. 11/040,227, filed on Jan. 20, 2005, which, itself, claims the priority benefit of U.S. Provisional Application No. 60/537,005, filed Jan. 20, 2004, each of which is incorporated herein by reference in its entirety.

### FIELD OF THE INVENTION

This invention relates generally to microporous membrane production and, more specifically, to producing microporous membranes exploiting the phenomenon of interfacial tension.

### BACKGROUND OF THE INVENTION

Porous membranes have utility in a wide variety of applications, most of which involve flow of a fluid or components of a fluid through pores of the membrane.

Filtration of air, water, and blood are the most common commercial applications of microporous membranes. A second significant application of such materials is in electrochemical cells (e.g. batteries, fuel cells, sensors, and capacitors) wherein membranes are used to separate the electrodes while allowing ions to flow therebetween. A third significant application is as a separator in a capacitor where the low dielectric constant of a highly porous insulating membrane is advantageous.

A number of basic processes have heretofore been used seeking to prepare various microporous membranes. These processes include: (i) laser drilling of holes which yields perforated, straight-thru, non-torturous holes in filter membranes; (ii) evaporation of dissolved gases in a melted or reactive polymer, followed by chemical, mechanical or thermal breakage of cell walls to produce open cell foams; (iii) addition and activation of chemical blowing agents followed by chemical, mechanical or thermal breakage of cell walls to produce open cell foams; (iv) addition of soluble particles at high concentration in the polymer, followed by dissolution of the soluble particles to produce filter membranes with pores that match their original particle sizes and locations; (v) addition of a plasticizer at a high concentration in the polymer, followed by extraction of the plasticizer by a low-boiling solvent to produce an open cell battery separator; (vi) compression of polymer particles within a liquid medium causing bonds to form between such particles, followed by stretching of the polymer film either uniaxially or biaxially to produce gas/liquid separation membranes; (vii) slitting of a polymer film followed by lateral stretching, (comparable to expanded metal sheet, to produce a battery separator having a straight-through path of a single membrane or a zigzag path of stacked membranes; (viii) sol-gel, internal phase inversion followed by evaporation of the solvent, then of the non-solvent from the polymer solution to produce an open-cell membrane; and (ix) sol-gel, external phase inversion, followed by addition of a non-solvent external to the polymer solution to produce an open cell filter membrane.

Some of these processes start with a solution of a thermoplastic polymer followed by removal of the liquid phase, and so does the process of this invention. Generally the prior art processes accomplish gelation of the polymer by placement of a film of the solution into a non-solvent bath that extracts the solvent from the solution. This causes an abrupt change in the solvent/non-solvent concentration that prompts an abrupt gelation of the polymer, usually forming a skin at the interface. The counter-flow of solvent and quenching non-solvent leads to strong concentration gradients and high variability of pore structure in membranes of prior art, contrary to the process of the present invention. When a non-solvent is added to the polymer solution, it has commonly been an alcohol having a relatively low interfacial tension.

Membranes made of polyvinylidene fluoride (PVDF) have been cited in the patent literature. Most are sheet membranes which are made by the common process of non-solvent (or poor solvent) intrusion to cause gelation or phase inversion, i.e. processes (viii) or (ix) above.

For example, U.S. Pat. No. 3,642,668 discloses dimethylsulfoxide (DMSO) or dimethylacetamide (DMAc) as the solvent for polyvinylidene fluoride when casting a membrane onto a support structure, immediately followed by immersion in a non-solvent bath, typically methanol.

U.S. Pat. No. 4,203,847 discloses flat sheet membranes formed by casting a nearly saturated PVDF solution in hot acetone solvent onto a heated moving belt which then passes (within 10 seconds) into a forming bath containing a mixture of 80% acetone solvent and 20% water non-solvent, followed by water washing. This produces a thin-skinned membrane.

U.S. Pat. No. 4,203,848 describes the belt and machine used in the '847 process.

U.S. Pat. No. 4,384,047 discloses the preparation of assymetrical vinylidene fluoride polymer ultrafiltration membranes by casting a sheet of the polymer dissolved in a mixture of a triethylphosphate solvent and a glycerol non-solvent, on a smooth substrate, evaporating a portion of the solvent from the sheet, immersing said sheet in a gelation liquid (ice water), and optionally, stabilizing the gelled sheet by heat treatment thereof.

U.S. Pat. No. 4,399,035 discloses a polyvinylidene fluoride membrane prepared by casting a dope comprising polyvinylidene fluoride, an active solvent such as DMAc, N-methylpyrrolidone or tetramethylurea and a minor amount of a surfactant or mixture of surfactants into a non-solvent bath, typically water or an alcohol. Polyethylene glycol and polypropylene glycol are used as surfactants and glycerin fatty acid esters are mentioned in the description as being suitable.

U.S. Pat. No. 4,464,238 defines “MacMullin Number,” NMAC, as the ratio of the electrical resistance of an electrolyte-saturated porous medium, R, to the resistance of an equivalent thickness and area of electrolyte, RO. MacMullin Number is a relative measure of resistance to movement of ions through a porous membrane.

U.S. Pat. No. 4,629,563 discloses ultraporous and microporous asymmetric membranes of numerous polymers. The membranes have an entirely reticulated structure free of large finger voids. The reticulated support structure has a gradually increasing pore size that reaches a maximum of from about 10 to about 20,000 times the diameter of the skin pores at the opposite face. Solvents which may be used include: dimethylformamide, dimethylacetamide, dioxane, N-Methyl pyrrolidone, dimethylsulfoxide, chloroform, tetramethylurea, and tetrachloroethane. The non-solvents include: methanol, heptane, ethanol, octane, isopropanol, acetone, amyl alcohol, methylethylketone, hexanol, methylisobutyl ketone, heptanol, nitropropane, octanol, butyl ether, propane, ethyl acetate, hexane, and amyl acetate. A mixture of 8 parts by weight polyvinylidene fluoride, 9.3 parts by weight glycerin, and 82.7 parts by weight dimethylformamide was stirred at ambient temperature for two hours. After degassing, the mixture had a turbidity of 0.8 optical density at 420 nanometers and was cast into water to form a membrane.

U.S. Pat. No. 4,666,607 describes a thermal gelation process. It discloses the use of a quench tube in the form of a U-tube, or a tank with the fibre moving as if in a U-tube, which can be used to produce polyvinylidene fluoride films or hollow fibers by extrusion of a solution comprising the polymer, solvent(s) and a non-solvent above the temperature at which the solution will separate into two phases, advantageously through an air gap into a cooling liquid in the quench tube or tank. In the case of hollow fibers, a lumen forming fluid (which is not a solvent for the polymer) is employed.

U.S. Pat. No. 4,810,384 describes a process wherein polyvinylidene difluoride and a hydrophilic polymer compatible therewith are dissolved in a mixture of lithium chloride, water and dimethylformamide, then cast onto a web and coagulated by passing the film through a water bath. A hydrophilic membrane that is a blend of the two polymers is produced.

U.S. Pat. No. 4,933,081 describes preparation of an assymetric microporous membrane having a layer of minimum pores inside. The membrane is produced by a kind of dry-wet method in which a gas is brought into contact with the surface of the spread solution before it is immersed in a solidifying bath to form a coacervation phase only in the surface layer of the spread solution. A homogeneous raw solution for forming a membrane was prepared by dissolving 20 parts of polyvinylidene fluoride, 60 parts of dimethylacetamide as a good solvent, and a non-solvent consisting of 10 parts of polyethyl-ene glycol 200, 10 parts of poly(vinylpyrrolidone) and 0.7 parts of water. The solution was spread evenly over a glass plate using a doctor blade to have a spread solution thickness of 150 microns. Warm air at 60 C (relative humidity 30%) was blown to the surface of the spread solution samples at a rate of 0.8 msec for up to 30 seconds. Then the samples were immediately immersed in warm water at 60° C. for 2 minutes and further in cool water at 20° C. The minimum pore layer was formed inside the membrane when warm air was blown for 2 to less than 30 seconds. The patent also uses water as a solvent for a film combining polysulfone and PVP (the PVP dissolves readily in water). The assymetric membranes had pore ratios (center size to skin size) ranging from 10 to 100.

U.S. Pat. No. 4,965,291 discloses a method of manufacturing a porous membrane by dissolving vinylidene fluoride polymer in a good solvent such as acetone and then causing solidification of the resultant solution in a nonsolvent. The dissolution of the vinylidene fluoride polymer in the solvent is done in a predetermined pressure condition, preferably in a range of 0.5 to 5.0 kg/cm2. A mixture of vinylidene fluoride and vinylidene fluoride/propylene hexafluoride copolymer in a weight ratio of 80:20 was added to acetone as a good solvent such that the polymer concentration was 19.0% by weight. The resultant solution was heated to 62° C. while pressurizing it to 1.0 kg/cm2 with agitation to obtain a uniform polymer solution. This solution was cast on a film which was then immersed in 1,1,2-trichloro-1,2,2-trifluoroethane and then dried to room temperature.

U.S. Pat. No. 5,013,339 describes preparing a polyvinylidene fluoride polymer membrane containing (1) a polyvinylidene fluoride polymer, (2) glycerol mono-acetate, glycerol diacetate, glycerol triacetate, or mixtures thereof, and (3) optionally glycerol, wherein the polyvinylidene fluoride polymer membrane so prepared is useful for a membrane liquid separation process such as microfiltration, ultra-filtration, dialysis, or membrane stripping. Preferably the polyvinylidene fluoride polymer membrane is made by forming a mixture of the composition, heating the mixture to a temperature at which the mixture becomes a homogeneous fluid, and extruding, molding, or casting the homogeneous fluid into water to form a porous membrane.

U.S. Pat. No. 5,387,378 describes fabricating an asymmetric fluoropolymer membrane having a first surface comprised of a dense layer of the fluoropolymer material, and an opposite second surface comprised of a porous layer of the fluoropolymer material, by (a) dissolving a fluoropolymer material in a solvent mixture of a low boiling point (40-60° C.) solvent and a high boiling point (140-200° C.) solvent to form a solution; (b) depositing the solution on a casting surface; and (c) removing the solvent from the solution, to precipitate the membrane. The solvent removing step requires two steps: (i) evaporating the solvent by air drying the solution for a sufficient period of time until the surface of the solution at the air interface has gelled, and then (ii) immersing the solution in a precipitation bath prepared from a major amount of a nonsolvent and a minor amount of a solvent.

U.S. Pat. No. 5,489,406 discloses a method of making a porous polymeric material by heating a mixture containing polyvinylidene fluoride and a solvent system of (i) a latent solvent (a glycerol ester such as glycerol triacetate, glycerol tripropionate, glycerol tributyrate and partially-esterified glycerol) and (ii) a non-solvent (e.g. a higher alcohol, glycol or polyol), at elevated temperatures. The patent specifically excludes active solvents such as acetone. The solution is extruded as a fiber and then rapidly cooled so that non-equilibrium liquid-liquid phase separation takes place to form a continuous polymer rich phase and a continuous polymer lean phase with the two phases being intermingled in the form of bicontinuous matrix of large interfacial area. Cooling is continued until the polymer rich phase solidifies. The polymer lean phase is then removed from the solid polymeric material by a lumenal gas wash procedure at a pressure of about 600 kPa (87 psi).

U.S. Pat. Nos. 5,834,107, 6,110,309, and 6,146,747 describe preparing a polyvinylidene difluoride membrane by adding a water-soluble polymer along with the PVDF, and then using humid air followed by hot water as the quench and extractant. More particularly, they provide a casting dope of about 12-20% by weight of PVDF and between up to 30% by weight of a hydrophilic polymer such as polyvinylpyrrolidone, dissolved in a solvent; casting the dope to form a thin film; exposing the thin film to a humid gaseous environment; coagulating the film in a water bath; and then recovering a formed asymmetric microporous PVDF membrane.

U.S. Pat. No. 5,922,493 describes an electrochemical cell having a positive electrode, an absorber-separator and a negative electrode wherein at least one of the electrodes or absorber-separator comprises a porous polyvinylidene fluoride. The porous polyvinylidene fluoride electrodes have an electrode material combined therewith, and the porous polyvinylidene fluoride absorber-separator has an electrolyte material combined therewith.

U.S. Pat. No. 6,013,688 describes methods for making microporous polyvinylidene fluoride (PVDF) membranes from vinylidene fluoride polymers and the products produced. The process includes dissolving the polymer at a temperature of 20 to 50 C. in a liquid that includes a solvent and a co-solvent for the polymer. The solvent:co-solvent mixture requires at least one solvent selected from N-methyl-2-pyrrolidone, tetrahydrofuran, methyl ethyl ketone, dimethylacetamide, tetramethyl urea, dimethyl sulfoxide and trimethyl phosphate. The co-solvent is preferably selected from formamide, methyl isobutyl ketone, cyclohexone, diacetone alcohol, isobutyl ketone, ethyl acetoacetate, triethyl phosphate, propylene carbonate, glycol ethers, glycol ether esters, and n-butylacetate. The solution is then heated or maintained at a desired temperature for a particular pore size. Then the solution is spread onto a solid surface to form a film and the solvent:co-solvent mixture is displaced from the film with a bath of a co-solvent:non-solvent liquid mixture.

U.S. Pat. No. 6,432,586 describes a separator for a high-energy rechargeable lithium battery and the corresponding battery in which the separator includes a ceramic composite layer and a polymeric microporous layer. The ceramic layer is a mixture of inorganic particles in a matrix material. The ceramic layer is adapted, at least, to block dendrite growth and to prevent electronic shorting. The polymeric layer is adapted, at least, to block ionic flow between the anode and the cathode in the event of thermal runaway.

U.S. Pat. No. 6,444,356 describes a secondary lithium battery separator of a fibrous core coated with a polymer having improved electrode adhesion properties in a unitary laminated construction. The separator is made of a pre-formed porous non-woven mat of a first homopolymer of polypropylene, polyethylene, or polyvinylalcohol, coated with a second homopolymer. Porosity of the homopolymeric coating, which may preferably be polyvinylidene difluoride, is obtained by first mixing the homopolymer with a low boiling solvent, e.g. acetone, and a non-aromatic aliphatic diester plasticizer, followed by forming a layer of the polymer-diester-acetone mixture on a fiber sheet, incorporating the sheet into a battery and then subjecting the entire structure to a vacuum to remove residual plasticizers.

U.S. Pat. No. 6,537,703 describes adding an alcohol to the polymer solution as a non-solvent. The alcohol, which has a low interfacial tension, is selected to evaporate at a temperature higher than the primary solvent (acetone), and the transition from liquid to solid involves selective evaporation of the acetone prior to that of the alcohol. This causes gelation of the polymer to occur. The process results in significant shrinkage of the film in its thickness direction (from 250 micron wet film to 50 micron dry film). Moreover it requires the use of fumed silica (7 parts silica per 10 PFDF polymer) to reinforce the film strength to make thin films.

U.S. Pat. No. 6,586,138 describes a freestanding battery separator that includes a microporous polymer web with passageways that provide overall fluid permeability which contains (i) ultra high molecular weight polyethylene (UHMWPE) and (ii) a gel-forming polymer material. In one embodiment, the gel-forming polymer material is a coating on the UHMWPE web surface. In a second embodiment, the gel-forming polymer material is incorporated into the UHMWPE web while retaining overall fluid permeability. Both embodiments produce hybrid gel electrolyte systems in which gel and liquid electrolyte coexist.

U.S. Pat. No. 6,994,811 describes a process for making macrovoid-free microporous membranes from a polymer solution and the membranes therefrom by means of a thermal assist, such as heating of the polymer solution subsequent to forming a film, tube or hollow fiber of the solution under conditions that do not cause phase separation. The formed solution is briefly heated to generate a temperature gradient through the body of the formed solution. The polymer in solution then is precipitated by immersion into a liquid bath of such as methanol to form a microporous structure by. The formation of a wide variety of symmetric and asymmetric structures can be obtained using this process. Higher temperatures and/or longer heating times effected during the heating step result in larger pore sizes and different pore gradients in the final membrane product.

U.S. Pat. No. 6,998,193 describes a battery having at least one positive electrode, at least one negative electrode, an electrolyte, and a homogeneous microporous membrane that contains (a) a hot-melt adhesive, (b) an engineering plastics, (c) optionally a tackifier, and (d) a filler having an average particle size of less than about 50 microns. The microporous membrane is bound permanently onto the surface of a positive electrode or a negative electrode. The hot-melt adhesive, engineering plastic, and filler are distributed in the microporous membrane.

US Pat. Appln. 2004/0241550-A1 describes a battery separator for a lithium battery in the form of a microporous membrane (generally UHMWPE) and coated on both sides. The coatings are made from a mixture of a gel forming polymer, a first solvent such as tetrahydrofuran, methylethylketone, acetone, low molecular weight glymes, and combinations thereof, and a second solvent or non-solvent such as propanol, isopropanol, butanol, and mixtures thereof. The first solvent is more volatile than the second solvent. The second solvent or non-solvent acts as a pore former for the gel-forming polymer. A small amount of water may also be added along with the second solvent or non-solvent. The first solvent is allowed to evaporate, preferably without the use of heat. Thereafter, the second solvent or non-solvent is removed in an oven with the application of heat. The process also requires a controlled high humidity for gelation when coated onto a Celgard film. By controlling the relative humidity (% RH) during the coating process, the uniformity of resistance (measured by the MacMullin Number) may be controlled. It has been determined that when the % RH is below 45%, the MacMullin Number (as defined in U.S. Pat. No. 4,464,238, incorporated therein by reference) may be controlled to be within the range of 5-12, preferably 5-6 with a coating density of about 0.25 mg/cm2.

Japanese Pat. No. 51-8268 uses cyclohexanone as a solvent for polyvinylidene difluoride. The solution is heated and then cooled during which time the solution passes through a region of maximum viscosity. The membrane is cast when the viscosity of the solution is decreasing. European Patent No. 223,709 discloses a mixture of acetone and dimethyl formamide (DMF) as a preferred solvent although all the usual standard or active solvents such as ketones, ethers such as tetrahydrofuran and 1,4 dioxane, and amides such as DMF, DMAC and DMSO are described. To form the membrane, the polymer solution is coated onto a substrate and then the coating is immediately immersed into a bath of a poor solvent. Most porous membranes to date have been directed toward the filtration of solids from liquids where an asymmetric filter has been of advantage (usually a fine porosity on the downstream side of the filter and more coarse porosity on the upstream side to entrap larger particles to avoid rapid clogging of the fine pores). However, some applications, particularly separators for battery electrodes, are more efficient if the membrane has fairly uniform porosity throughout the thickness of the membrane so that ionic flow (ions do not clog) can be unimpeded for maximum current flow (charging and discharging currents).

The present process and its products are distinct from the processes and products of the prior art. The process allows the rapid formation of highly porous, substantially uniform, thin membranes having sufficient strength as to be easily handled. Moreover, the process avoids the use of liquid extraction baths and the disposal problems associated therewith.

### DETAILED DESCRIPTION OF THE PREFERRED EMBODIMENT

The present invention is directed to the production of highly porous polymer membranes with open cells of relatively uniform size throughout the thickness of each membrane. Cell size and percent porosity are controllable by the composition of the starting polymer solution in combination with the process conditions used to cause transition of that solution into a flat or tubular membrane.

The present invention describes and utilizes a method for controlling the pores in a microporous polymer to be well-controlled in shape and size, and resulting in high porosity. Before the materials and procedures that give specific embodiments of this method are described below, some underlying physical principles are first presented here.

Micropores are formed in a previously uniform material or solution containing polymer by the displacement of polymer molecules away from multiple regions of microscopic size that will become voids. Phase separation, by changes in physical conditions such as temperature or composition, is one way to produce the forces to achieve such displacement. In the physical sciences, a phase is a region of space (a thermodynamic system), throughout which all physical properties of a material are essentially uniform. Examples of physical properties include density, index of refraction, and chemical composition. A simple description is that a phase is a region of material that is chemically uniform, physically distinct, and (often) mechanically separable.

Between two phases in equilibrium there is a narrow region where the properties are not that of either phase. Although this region may be very thin, it can have significant and easily observable effects, such as causing a liquid to exhibit surface tension. In mixtures, some components may preferentially move toward the interface. In the case of the polymer in solution, the original solution separates into phases, one rich in polymer (which we herein sometimes simply call “polymer”), the other, usually a liquid, poor in polymer, because in doing so, the entire system can lower its energy (or free energy—these terms will be used interchangeably here).

Throughout this disclosure the term “gel” or “gelled polymer” will be used to describe the middle state between solution and a formed solid polymer. A gel is an elastic colloid or polymer network that is expanded throughout its whole volume by the liquid. The gel is the result of the phase separation described herein. It is in the gel state that original solution has separated into the polymer and liquid phases by virtue of the change in temperature or composition to form the gel.

During the change in temperature or composition, the system thus goes from a state where the polymer and the liquid prefer to be in intimate contact at a molecular level to one where they do not. In other words, the liquid changes from being a solvent to a non-solvent for the polymer. Note that the original liquid may comprise several liquid components, and these components may partition into solvents that stay in the polymer-rich phase, and non-solvents that do not.

The degree to which the separating phases do not like to be in contact is termed the “interfacial tension” defined as the energy required in creating a unit area of interface between the polymer-rich and liquid phases. Other terms commonly used to refer to interfacial tension include “interfacial energy,” “surface energy,” or “surface tension;” these terms are used interchangeably herein, although interfacial tension remains the preferred term. The interfacial tension is the principal phenomenon the inventive method exploits in determining the size and shape of the regions formed. Specifically, high interfacial tensions favor production of regions in the form of spherical pores since forming spherical pores requires less energy than flat or elongate pores, spheres having the lowest interfacial area for a given volume. The larger the region, the less area per volume is required, and so the sizes of regions typically grow with time. The void size in a microporous polymer is thus expected to be controlled by the time of separation and the rate of polymer displacement, which may depend on cooling and other rates.

When three phases are present, such as polymer, liquid and vapor, or polymer, liquid and a solid substrate, a comparison of the three interfacial tensions (one for each pair of phases) determines the degree to which one phase “wets” another. For instance, if the polymer/liquid interfacial tension is much greater (lower) than the polymer/vapor interfacial tension, the liquid becomes non-wetting (wetting) for the polymer. Since vapor has low density, the interfacial tension of a solid or liquid material with vapor (or air or vacuum) is often termed the surface tension or energy, and materials are commonly classified as having high surface energy or low surface energy. For liquids, there is a rough correlation of surface tension and boiling point temperature, as both are a measure of the energy required to break apart molecules in the liquid. As such, surface tension or energy, boiling point, or vapor pressure are all properties of a single material. In contrast, interfacial tension is a property between a pair of materials. Nonetheless, high surface energy or “high surface tension” materials often, but not always, have high interfacial tensions with other materials, since the strong molecular interactions are disrupted at the interface. Where the high interfacial energy is used to form pores, high porosity of the final material results if the phase separated polymer is structurally stabilized around proportionally large volumes of a non-solvent liquid, and then this non-solvent liquid is suitable removed.

In a first embodiment the present invention is directed to a method of producing a symmetric, strong, highly porous, microporous polymer film by:

(a) forming a layer of a polymer solution on a substrate, wherein the polymer solution comprises two miscible liquids and a polymer material dissolved therein, wherein the two miscible liquids comprise (i) a principal solvent liquid that has a interfacial tension at least 5% lower than the interfacial tension of the polymer and (ii) a second liquid that has a interfacial tension at least 5% greater than the interfacial tension of the polymer;

(b) producing a film of gelled polymer from the layer of polymer solution under conditions sufficient to provide a non-wetting, high interfacial tension solution within the layer of polymer solution; and

(c) rapidly removing the liquid from the film of gelled polymer by unidirectional mass transfer without dissolving the gelled polymer to produce the strong, highly porous, microporous polymer film.

In a second embodiment, the present invention is directed to a method of preparing highly porous, strong, thin, polymer membranes with symmetric open cells of a relatively uniform size throughout the thickness of each membrane by:

(a) preparing a solution of one or more polymers in a mixture of a principal liquid which is a solvent for the polymer and a second liquid which is miscible with the principal liquid, wherein (i) the principal liquid has a interfacial tension at least 5% lower than the interfacial tension of the polymer, (ii) the second liquid has a interfacial tension at least 5% higher than the interfacial tension of the polymer, (iii) the normal boiling point of the principal liquid is less than 125° C. and the normal boiling point of the second liquid is less than about 160° C., (iv) the polymer has a lower solubility in the second liquid than in the principal liquid, and (v) the solution is prepared at a temperature less than about 20° C. above the normal boiling point of the principal liquid and while precluding any substantial evaporation of the principal liquid;

(b) reducing the temperature of the solution by at least 5° C. to between the normal boiling point of the principal liquid and the temperature of the substrate upon the solution is to be cast;

(c) casting the polymer solution onto a high interfacial tension substrate to form a liquid coating thereon, said substrate having a interfacial tension greater than the interfacial tension of the polymer; and

(d) removing the principal liquid and the second liquid from the coating by unidirectional mass transfer without use of an extraction bath, (ii) without re-dissolving the polymer, and (iii) at a maximum air temperature of less than about 100° C. within a period of about 5 minutes, to form the strong, highly porous, thin, symmetric polymer membrane.

In a third embodiment, the present invention is directed to a method of preparing a strong, thin, symmetric microporous polymer membrane by:

(i) dissolving about 3 to 20% by weight of a polymer in a heated multiple liquid system comprising (a) a principal liquid which is a solvent for the polymer and (b) a second liquid to form a polymer solution, wherein (i) the principal liquid has a interfacial tension at least 5% lower than the interfacial tension of the polymer, (ii) the second liquid has a interfacial tension at least 5% greater than the interfacial tension of the polymer; and

(iii) the polymer has a lower solubility in the second liquid than it has in the principal solvent liquid;

(ii) reducing the temperature of the solution by at least 5° C. to between the normal boiling point of the principal liquid and the temperature of the substrate upon which it will be cast;

(iii) casting a film of the fully dissolved solution onto a substrate which has a higher interfacial tension than the interfacial tension of the polymer;

(iv) precipitating the polymer to form a continuous gel phase while maintaining at least 70% of the total liquid content of the initial polymer solution, said precipitation caused by a means selected from the group consisting of cooling, extended dwell time, solvent evaporation, vibration, or ultrasonics; and

(v) removing the residual liquids without causing dissolution of the continuous gel phase by unidirectional mass transfer without any extraction bath, at a maximum film temperature which is less than the normal boiling point of the lowest boiling liquid, and within a period of about 5 minutes, to form a strong, highly porous, thin, symmetric polymer membrane.

Each of the processes begins with the formation of a solution of one or more soluble polymers in a liquid medium that comprises two or more dissimilar but miscible liquids. To form highly porous products, the total polymer concentration will generally be in the range of about 3 to 20% by weight. Lower polymer concentrations of about 3 to 10% are preferred for the preparation of membranes having porosities greater than 70%, preferably greater than 75%, and most preferably greater than 80% by weight. Higher polymer concentrations of about 10 to 20% are more useful to prepare slightly lower porosity membranes, i.e. about 60 to 70%.

A suitable temperature for forming the polymer solution generally ranges from about 40° C. up to about 20° above the normal boiling point of the principal liquid, preferably about 40 to 80° C., more preferably about 50° C. to about 70° C. A suitable pressure for forming the polymer solution generally ranges from about 0 to about 50 psig. Preferably a sealed pressurized system is used.

This invention requires the presence of at least two dissimilar but miscible liquids to form the polymer solution from which a polymer film is cast. The first “principal” liquid is a better solvent for the polymer than the second liquid and has an interfacial tension at least 5%, preferably at least 10%, lower than the interfacial tension of the polymer involved. The second liquid may be a solvent or a non-solvent for the polymer and has an interfacial tension at least 5%, preferably at least 10%, greater than the interfacial tension of the polymer. The interfacial tension selected in practicing the inventive method is a primary system parameter that controls morphology development during phase separation. In essence, the interfacial tension is a measure of the degree to which two components prefer energetically to separate into different spatial regions. The property of interfacial tension, pertaining to pairs of compounds, can be correlated with molecular scale properties such as polarity, charge, hydrophobicity, and capacity to hydrogen bond. While these same molecular scale properties can also influence boiling point, the interfacial tension is nonetheless a distinct property. Moreover, because boiling point is a single component property, and interfacial tension is a two component property, there will be significant cases where boiling point is not a predictor of interfacial tension. A boiling point criterion will therefore not give the same combinations of compounds as the interfacial tension criterion. Furthermore, one can expect that the interfacial tension criterion will select those relationship between the nonsolvent and either polymer or solvent could exist to further isolate and shape those small domains into pores of desirable geometries (typically spherical). These spherical pores combine to form the tortuous path that is desirable as an effective membrane.

The invention does not require and avoids the use of a special gelation medium.

The principal liquid is at least 70%, preferably about 80 to 95%, by weight of the total liquid medium. The principal liquid can dissolve the polymer at the temperature and pressure at which the solution is formed. The dissolution will generally take place near or above the boiling temperature of the principal liquid, usually in a sealed container to prevent evaporation of the principal liquid. The principal liquid has a greater solvent strength for the polymer than the second liquid. Also the principal liquid has a interfacial tension at least about 5%, preferably at least about 10%, lower than the interfacial tension of the polymer. The lower interfacial tension often leads to better polymer wetting and hence greater solubilizing power.

The second liquid, which generally represents about 1 to 10% by weight of the total liquid medium, must be miscible with the first liquid. It does not normally dissolve the polymer as well as the first liquid at the selected temperature and pressure and it has a higher interfacial tension than the interfacial tension of the polymer. Preferably the second liquid does not wet the polymer at the gelation temperature though it may wet the polymer at more elevated temperatures. Often the non-solvent liquid component, having high interfacial tension with the polymer during pore formation, would also have high interfacial tension if mixed with the polymer alone at the conditions under which the polymer solution is made. Thus in such cases, it is critical that the non-solvent and low interfacial tension solvent are mixed together to form a binary solvent for the polymer to enable the preliminary formation of a homogeneous polymer solution. However, it is the presence of the low interfacial tension that allows the close contact of the high-interfacial tension non-solvent molecules with the polymer prior to gel formation that promotes good pore formation later.

Thus, a stable but sometimes highly swelled polymer gel is formed initially from the polymer solution. Without being bound by any theory, it is believed that the preferred gelled polymer comprises a solid that is surrounded by high surface tension, non-wetting liquid (one with high interfacial tension with polymer). As conventionally described, the term “solvent” refers to a liquid that is used primarily to dissolve the polymer material, and the term “non-solvent” refers to a liquid that is believed to be responsible for the formation of micropores at the time of gel formation (although it may have been a component of a binary solvent when the polymer was in solution). However, it should be appreciated that a liquid as described herein can function both as a dissolving agent and pore former. Any liquid or combination of liquids that in essence functions as both a “solvent” first, and then as a “non-solvent” at different points within a narrow range of temperatures and compositions is particularly useful in the present invention.

Table A and Table B identify some specific principal and second liquids for use with typical polymers, especially including PVDF, that meet the requirements for the present invention. Table A lists liquids that have at least some degree of solubility towards PVDF (interfacial tension of 35 dyne/cm), which is required to produce the dissolved polymer solution in the first step of the process. Ideally, a liquid is selected from Table A that has solubility limits between 1% and 50% by weight of polymer at a temperature within the range of about 20 and 90° C. The liquids in Table B, on the other hand, have lower polymer solubility than those in Table A, but more importantly are selected because they have a higher interfacial tension than both the principal liquid and the polymers that are dissolved in the solution made with liquid(s) from Table A.

Suitable liquids for use as the principal liquid, along with their boiling point and interfacial tensions are provided in Table A below. The table is arranged in order of increasing boiling point—the most useful parameter for achieving rapid gelling and removal of the liquid during the film formation step. In general, a lower boiling point is preferred.

TABLE A

| | Normal Boiling | Interfacial tension, |
|---|---|---|
| Principal Liquid | Point, ° C. | dynes/cm. |
| methyl formate | 31.7 | 24.4 |
| acetone (2-propanone) | 56 | 23.5 |
| methyl acetate | 56.9 | 24.7 |
| tetrahydrofuran | 66 | 26.4 |
| ethyl acetate | 77 | 23.4 |
| methyl ethyl ketone (2-butanone) | 80 | 24 |
| acetonitrile | 81 | 29 |
| dimethyl carbonate | 90 | 31.9 |
| 1,2-dioxane | 100 | 32 |
| toluene | 110 | 28.4 |
| methyl isobutyl ketone | 116 | 23.4 |

Suitable liquids for use as the second liquid, along with their boiling point and interfacial tensions are provided in Table B below. This table is arranged in order of increasing interfacial tension as that parameter is most useful (i.e., in general, higher interfacial tension is better) for achieving the combination of high porosity, high strength and small, uniform pore size distributions during the subsequent polymer gelling and liquid removal steps of the process.

TABLE B

| | Normal Boiling | Interfacial tension, |
|---|---|---|
| Second Liquid | Point, ° C. | dynes/cm. |
| nitromethane | 101 | 37 |
| bromobenzene | 156 | 37 |
| formic acid | 100 | 38 |
| pyridine | 114 | 38 |
| ethylene bromide | 131 | 38 |
| 3-furaldehyde | 144 | 40 |
| bromine | 59 | 42 |
| tribromomethane | 150 | 42 |
| quinoline | 24 | 43 |
| nitric acid (69%) | 86 | 43 |
| water | 100 | 72.5 |

The present invention uses a unique liquid medium for forming the polymer solution. The liquid medium is rapidly removable at a sufficiently low temperature that the liquid removal does not cause the formed polymer gel to re-dissolve during the liquid removal process. The liquid medium is devoid of plasticizers. The liquids that form the liquid medium are relatively low boiling point materials. The liquids normally boil at temperatures less than about 125° C., preferably about 100° C. and below. Somewhat higher boiling point liquids, i.e. up to about 160° C., may be used as the second liquid if at least about 60% of the total liquid medium is removable at low temperature, e.g. less than about 50° C. The balance of the liquid medium can be removed at a higher temperature and/or under reduced pressure. Suitable removal conditions depend upon the specific liquids, polymers, and concentrations utilized.

In one embodiment high interfacial tension with the polymer during gel formation, can serve as the sole liquid component in the polymer solution. The liquid portion of the solution need not, but can also include a “low interfacial tension liquid”. When both a high surface tension liquid and a low interfacial tension liquid are present in the polymer solution, it is desirable that the high surface tension liquid has have a lower volatility, i.e., lower vapor pressure, than the low interfacial tension liquid such that a sufficient amount of the high surface tension liquid remains in the solution subsequent to any removal, e.g., via evaporation or other means, of an accompanying low surface tension liquid to form the gel phase. After the gel phase has formed, the remaining high surface tension liquid can be removed to form the porous polymer. Typically, the high surface tension liquid is removed from the gel phase by direct air drying or other simple method such as suction, blotting, surface rinsing, etc. without the need for liquid extraction, high vacuum, heat or other complex steps.

High interfacial tension of the liquid that is left behind, e.g. because of lower volatility of the high interfacial tension liquid forms the pores. Should this lower boiling point liquid have only moderate interfacial tension with the polymer, the interface between the two is not as strongly coerced to be spherical, and the resulting pores may have shapes that are variable, wispy, or ill-defined. This is the case, for instance, in the commonly used alcohol non-solvents. On the other hand, the desire for the residual non-solvent liquid to have high-interfacial tension with the polymer often necessitates the mixing with the low-interfacial tension liquid to form a binary solvent to dissolve polymer initially in this process.

Preferably the liquid removal is completed within a short period of time, e.g. less than 5 minutes, preferably within about 2 minutes, and most preferably within about 1.5 minutes. Rapid low temperature liquid removal, preferably using air flowing at a temperature of about 80° C. and below, most preferably at about 60° C. and below, without immersion of the membrane into another liquid has been found to produce a membrane with enhanced uniformity.

The liquid removal is preferably done in a tunnel oven with an opportunity to remove and/or recover flammable, toxic or expensive liquids. The tunnel oven temperature is generally operated at a temperature less than about 90° C., preferably less than about 60° C. The polymer solution as formed may be supersaturated, but more commonly as formed it is not supersaturated. Rather the solution becomes supersaturated prior to film formation. Generally cooling of the solution will cause the supersaturation. Alternatively, the solution becomes supersaturated after film formation by means of evaporation of a portion of the principal liquid. In each of these cases, a polymer gel is formed while there is still sufficient liquid present to generate the desired high void content in the resulting polymer film when that remaining liquid is subsequently removed.

After the polymer solution has been prepared, it is then formed into a thin film. The film-forming temperature is preferably lower than the solution forming temperature. The film-forming temperature should be sufficiently low that a polymer gel will rapidly form. That gel must then be stable throughout the liquid removal procedure. A lower film-forming temperature can be accomplished, for example, by pre-cooling the substrate onto which the solution is deposited, or by self-cooling of the polymer solution by controlled evaporation of a small amount of the principal liquid.

The film-forming step usually occurs at a lower temperature (and often at a lower pressure) than the solution-forming step. Commonly, it occurs at or about room temperature. However, it can occur at any temperature and pressure, if precipitation of the polymer is caused by means other than cooling, e.g. by slights drying, extended dwell time, vibrations, or the like. Application as a thin film allows the polymer to precipitate in a geometry defined by the interaction of the liquids of the solution.

The thin film may be formed by any suitable means. Extrusion or flow through a controlled orifice or by flow through a doctor blade is most common. The substrate onto which the solution is deposited should have a interfacial tension higher than the interfacial tension of the polymer. Examples of suitable substrate materials (with their surface energies) include copper (44 dynes/cm), aluminum (45 dynes/cm), glass (47 dynes/cm), polyethyl eneterephthalate (44.7 dynes/cm), and nylon (46 dynes/cm). Preferably a metal, metalized or glass surface is used. More preferably the metalized surface is an aluminized polyalkylene such as aluminized polyethylene and aluminized polypropylene.

In view of the thinness of the films, the temperature throughout is thought to be relatively uniform, though the outer surface may be slightly cooler than the bottom layer. Thermal uniformity may enable the subsequent polymer precipitation to occur in a more uniform manner.

The films should be cooled/dried in a manner that prevents coiling of the polymer chains. Thus the cooling/drying should be conducted rapidly, i.e. within about 5 minutes, preferably within about 3 minutes, most preferably within about 2 minutes, because a rapid solidification of the spread polymer solution facilitates retention of the partially uncoiled orientation of the polymer molecules when first deposited from the polymer solution.

The process entails producing a film of gelled polymer from the layer of polymer solution under conditions sufficient to provide a non-wetting, high interfacial tension solution within the layer of polymer solution. Preferably gelation of the polymer into a continuous gel phase occurs while maintaining at least 70% of the total liquid content of the initial polymer solution. More particularly, the precipitation of the gelled polymer is caused by a means selected from the group consisting of cooling, extended dwell time, solvent evaporation, vibration, or ultrasonics. Then, the balance of the liquids are removed by a unidirectional process, usually by evaporation, from the formed film to form a strong micro-porous membrane of geometry controlled by the combination of the two liquids in the medium. The present invention avoids the use of a liquid bath to extract the liquids from the membrane. Rather, the liquid materials preferably evaporate at moderate temperatures, i.e. at a temperature lower than that used for the polymer dissolution to prepare the polymer solution. The reduced temperature may be accomplished by the use of cool air or even the use of forced convection with cool to slightly warmed air to promote greater evaporative cooling.

The interaction among the two liquids (with their different interfacial tension characteristics) and the polymer (with a interfacial tension intermediate the interfacial tensions of the liquids) yields a membrane with high porosity and relatively uniform pore size throughout its thickness. The interfacial tension forces act at the interface between the liquids and the polymer to give uniformity to the cell structure during the removal step. The resulting product is a solid polymeric membrane with relatively high porosity and uniformity of pore size. The strength of the membrane is surprisingly high, due to the more linear orientation of polymer molecules.

The ratio of the principal liquid to the second liquid at the point of gelation needs to be such that the interfacial tension of the composite liquid phase is greater than the interfacial tension of the polymer. The calculation of the composite liquid interfacial tension can be predicted based upon the mole fractions of liquids, as defined in “Surface Tension Prediction for Liquid Mixtures,” AIChE Journal, vol. 44, no. 10, p. 2324, 1998, the subject matter of which is incorporated herein by reference.

Thermodynamic calculations show that adiabatic cooling of a solution can be significant initially and that the temperature gradient through such a film is very small (in contrast to concentration gradients of the prior art). The latter is thought responsible for the exceptional uniformity obtained by the present invention.

Adiabatic cooling calculations based on the formulation of Example 1 below, show that the temperature drop starts out at 3.1° C. for each 1 percent of acetone that evaporates from the film. The temperature gradient across a 500-micron thick wet film would then be 0.13° C. for each 1% of acetone evaporated from the film. By the time that 4% of the acetone evaporates (presumed adiabatically) the temperature drop can be 12° C. and the temperature gradient is only 0.52° C. If the substrate is pre-cooled this temperature drop can be increased considerably while maintaining a low temperature gradient.

After gelation has occurred, somewhat higher temperatures can be used to facilitate removal of the remaining liquids therefrom, so long as the temperature is not so high that the gel redissolves. The maximum liquid removal temperature is preferably less than about 100° C., more preferably less than about 80° C., and most preferably less than about 60° C.

The polymers used to produce the microporous membranes of the present invention are organic polymers. Accordingly, the microporous polymers comprise carbon and a chemical group selected from hydrogen, halogen, oxygen, nitrogen, sulfur and a combination thereof. In a preferred embodiment, the composition of the microporous polymer includes a halogen. Preferably, the halogen is selected from the group consisting of chloride, fluoride, and a mixture thereof.

Suitable polymers for use herein are either semi-crystalline or a blend of at least one amorphous polymer and at least one crystalline polymer. Preferred semi-crystalline polymers of the present invention are selected from the group consisting of polyvinylidene fluoride, polyvinylidene fluoridehexafluoropropylene copolymer, polyvinyl chloride, polyvinylidene chloride, chlorinated polyvinyl chloride, polymethyl methacrylate, and mixtures of two or more of these semi-crystalline polymers.

Preferably the products produced by the process of this invention are used as a battery separator. For this use, the polymer will most commonly comprise a polymer selected from the group consisting of polyvinylidene fluoride (PVDF), polylvinylidene fluoride-hexafluoropropylene copolymer (PVDF-HFP), polyvinyl chloride, and mixtures thereof. Still more preferably the polymer will comprise at least about 75% polyvinylidene fluoride.

The “MacMullin” or “McMullin” Number measures resistance to ion flow as defined in U.S. Pat. No. 4,464,238, the subject matter of which is incorporated herein by reference. The MacMullin Number is “a measure of resistance to movement of ions. The product of MacMullin Number and thickness defines an equivalent path length for ionic transport through the separator. The MacMullin Number appears explicitly in the one-dimensional dilute solution flux equations which govern the movement of ionic species within the separator; it is of practical utility because of the ease with which it is determined experimentally.” The lower a MacMullin Number the better for battery separators. Products of the present invention have a low MacMullin number, i.e. about 1.05 to 3, preferably about 1.1 to less than 2, most preferably about 1.2 to about 1.8.

Good tortuosity is an additional attribute of the membranes of this invention. A devious or tortuous flow path with multiple interruptions and fine pores acts as a filter against penetration of invading solids. Tortuosity of the flow path can be helpful to prevent penetration by loose particles from an electrode or to minimize growth of dendrites through a separator that might cause electrical shorts. This characteristic cannot be quantified, except by long-term use, but it can be observed qualitatively by viewing a cross-section of the porosity. Each orifice (many about 1 micron in diameter) between adjacent voids represents a filter to capture loose particles or a barrier to growth of dendrites.

The membranes produced by the present process are generally uniform and symmetric, i.e. the substrate side pores are substantially similar in size to the central and the air side pores. Pores varying in diameter by a factor of about 5 or less are sufficiently uniform for the membranes to function in a symmetric manner. While some variation in pore sizes may occur and it may be of merit in an electrode separator where loose particles or dendrites are a particular problem, generally the more symmetric a membrane, the better performance as a battery separator. Prior art asymmetric PVDF membranes have had variations in pore sizes ranging from 10 to several hundred.

Numerous polymer membranes have been prepared using variations of the procedure of Example 1 and have provided films with thickness ranging from about 15 to 100 microns, with porosities up to 95%, with Gurley flow numbers as low 0.1 second, and MacMullin numbers of 1.05 to 1.5. Permeabilities were as high as 1870 cm micron cpoise/minute Torr. Mercury porosimetry tests have shown the presence of some large pores ranging from 0.2 micron diameter up to 7 microns in different membranes, but with average pore sizes ranging from about 0.2 to 1.0 micron. Films have been produced with average pore diameters of 0.245 micron (85% porosity) and 0.398 microns (86% porosity). Prior art films have shown far smaller average pore diameters, e.g. 0.064 micron and correspondingly a far lower porosity (57%).

The percentage of blind pores ranges from less than 1% to a maximum of 10% in some inferior films. Surface areas are usually in the range of about 5 to 8 sq. meters/gm.

Highly porous membranes have been cast directly onto battery electrodes and onto porous structures (e.g. non-woven films) thus obviating or facilitating mechanical transfer. This permits higher porosity separators to be made without the necessity of high tensile strength and tensile modulus.

Where additional strength or stiffness may be needed for handling purposes, micro- or nano-particles can be added to the formulation with such particulates residing within the polymer phase. A few such additives include silica aerogel, talc, and clay.

Accordingly, the present invention makes a product that has significantly better flow characteristics, strength, and uniformity than the prior art, as shown by the following examples, in which all parts and percents are by weight unless otherwise specified. A conductivity meter, model TL201 from Timberline Instruments, was used to test electrical resistance in the examples below. Electrodes were made of 100-mesh stainless steel screen 1 cm in diameter. The electrolyte was 1 molar lithium perchlorate dissolved in propylene carbonate. Reference resistances were measured with synthetic fiber spacers of about 1-mil diameter, and membrane resistances were measured using wetted membranes.

### Example 1

A polymer solution was prepared with the following formulation heated in a pressure chamber to 60° C. and 20 psig with stirring: 1 part Kynar 2801 PVDF-HFP copolymer; 1 part Kynar 761 PVDF homopolymer, 4 parts Kynar 301F PVDF homopolymer, 90.5 parts acetone (industrial grade), 3.5 parts water.

The solution was allowed to cool to room temperature (about 23° C.). A first portion was allowed to stand overnight and it did not gel visibly within a period of 24 hours but it was observed to gel after a longer period at room temperature, indicating that the solution was supersaturated.

A second portion within 3 hours of mixing was flowed through a slotted die onto a conveyed aluminum foil 3 mils thick. The aluminum foil had a interfacial tension of about 45 dynes/cm. The polymer solution had been cooled to about 35° C. and cast at that temperature onto the aluminum foil open to the atmosphere. The wet membrane as cast was about 200-250 microns thick. The acetone and water were caused to evaporate and the membrane dry by the flow of warm air from a multiplicity of different devices at about 350 fpm horizontal airflow for about 100 seconds, until the membrane turned from clear to white.

Calculations show that the interfacial tension of the solvent mixture of Example 1 increased rapidly to exceed that of the polymer as evaporation of the primary solvent occurred. When the acetone had evaporated sufficiently to change the volume concentration of polymer from its initial 2.1 mol % (6 wt %) up to 10 mol %, the interfacial tension of the liquid mixture had increased from an initial 29 dynes/cm to 39 dynes/cm, thus exceeding that of the polymer during the process of forming voids and pores. The calculation was based upon the mol fractions of liquids, as defined in “Surface Tension Prediction for Liquid Mixtures,” AIChE Journal, vol. 44, no. 10, p. 2324, 1998.

The resultant dried films were 27-30 microns thick and had the following characteristics: Gurley number 0.10 seconds (30 microns thick); air permeability 5.3-9.2×104 cm micron/minute Torr; tensile modulus 25,800 psi; tensile yield 2,000 psi; and MacMullin Number: 1.1-1.4. The porosity was measured to be about 80% by absorption of isopropanol.

The surface voids were measured as being: air side average 2.5 microns, standard deviation 2.1 microns; substrate side average 1.7 microns, standard deviation 1.3 microns.

The PVDF formulation of this example was ascertained by a parametric study of different PVDF polymers and copolymers, directed toward enhanced wet strength in ethylene carbonate and ethyl methyl carbonate battery electrolytes.

These membranes showed good handling characteristics and high porosity.

### Example 2

A PVDF polymer solution was prepared and a film was made as in Example 1.

The dried films were approximately 30 microns thick and were found to the following characteristics: Gurley number 0.19 seconds (30 microns thick); air permeability 29×104 cm micron/minute Torr; tensile modulus 26,000 psi; tensile yield 2,000 psi; puncture resistance tup with 1/16″ radius, membrane clamped 1″ diameter, force to penetrate 81.2 grams/mil thickness, test patterned after ASTM D6241; MacMullin Number 1.15-1.20; and porosity of about 80% as determined by isopropanol absorption.

The surface voids were measured as being: air side average 2.6 microns, standard deviation 1.6 microns; substrate side average 0.8 microns, standard deviation 0.5 microns.

### Example 3

A PVDF polymer solution was prepared as in Example 1. The solution was placed in an applicator where it first flowed through a series of mechanical filters to remove any unseen gels, and then was caused to flow through a slotted die onto a conveyed aluminum foil (interfacial tension about 800 dynes/cm), forming a wet film. Room air was caused to flow above the wet film to commence evaporation of the acetone and water, which provided cooling to the film. An opaque matrix was seen within 30 seconds after the wet film was applied, and the conveyor with film then passed through a tunnel oven for about 100 seconds using heated air (at 37° C.) to evaporate the acetone and remove much of the water from the membrane. The membrane was removed by peeling it from the substrate so it could be tested as a free film.

The resulting films had sufficient strength to be easily handled and the following characteristics: dried films were 20 microns thick, standard deviation 1.3 microns; Gurley number, calculated for 10 cc air flow, 1 sq. in. area and constant 12.5 inch water column pressure, range of 10 specimens, 0.10 to 0.17 seconds, depending upon thickness; air permeability 5.3-9.2×104 cm micron/minute Torr; fluid permeability 9.5-16.5×102 cm cpoise micron/minute Torr; puncture resistance tup with 1/16″ radius, membrane clamped 1″ diameter, force to penetrate 97.2 grams/mil thickness, test patterned after ASTM D6241; MacMullin Number 1.3-1.6 as measured using a battery electrolyte of 1 molar lithium perchlorate in propylene carbonate; porosity of 60-70%, as calculated from bulk density and original polymer density; average open void size determined from scanning electron microscope photos, 43 voids measured on diagonals: (i) air side average 5.05 microns, standard deviation 2.22 microns, (ii) center average 1.25 microns, standard deviation 0.63 microns, (iii) substrate side average 1.77 microns, standard deviation (non-random) 1.17 microns (Asymmetry as ratio of average void sizes, air side/substrate side, 2.85. The surface voids are noted to be considerably larger than the layer of pores immediately below the surface, which are comparable to the center pores.); puncture resistance, tup with 1/16″ radius, membrane clamped 1″ diameter, force to penetrate 97.2 grams/mil thickness, test patterned after ASTM D6241.

Strength and stiffness measurements were as shown in the following table:

TABLE C

| | | Machine | Transverse |
|---|---|---|---|
| Property | Test Method | Direction | Direction |
| Tensile strength, psi | ASTM D882 | 860 | 600 |
| Tensile Elongation, % | ASTM D882 | 19 | 9 |
| Matrix Tensile Strength, psi | Gore definition | 2150 | 1500 |
| Tensile Modulus, psi | ASTM D882 | 21,000 | — |

This membrane was applied onto an aluminum foil that may have had some residual oil which caused beading of a drop of water on its surface; this was a probable cause for the slight asymmetry of porosity at the substrate surface and for the about 10% lower porosity than expected.

### Example 4

A run was made using aluminized polypropylene film as the substrate in place of the aluminum foil of Example 3. This solution was prepared and the membrane was cast as in Example 1, except that the substrate was cooled upstream of the applicator by lightly treating it with water. No water was visible on the substrate when the solution was deposited thereon. This substrate had a lower thermal conductivity and a lower thermal diffusivity than the aluminum substrate of Example 3. The effect of the cooling, if any, has not been explored.

The membranes had very similar air and substrate side appearances. The membranes peeled off the substrate more easily than some of the prior examples.

Some of the characteristics of this membrane were: (i) thickness, average 33.5 microns, standard deviation 6.9 microns; (ii) porosity, as calculated from bulk density and original polymer density, 78.5%; (iii) Gurley number, calculated for 10 cc air flow, 1 sq. in. area and constant 12.5 inch water column pressure, range of 10 specimens, less than 1 second, depending upon thickness; (iv) air permeability 44×104 cm. micron/minute Ton; (v) fluid permeability 79×102 cm cpoise micron/minute Torr, calculated from air flow; (vi) water permeability, 86×102 cm cpoise micron/minute Ton measured using water containing 0.1% Triton X-100 (octoxynol) surfactant; (vii) average open void size from SEM photographs, 74 voids measured on diagonals. The air side average voids were 1.80 microns, standard deviation 1.3 microns. The center average voids were 1.63 microns, standard deviation 0.96 microns. The substrate side average voids were 1.44 microns, standard deviation (non-random) 1.0 microns. The ratio of average void sizes, air side/substrate side was 1.25; (viii) puncture resistance, tup with 1/16″ radius, membrane clamped 1″ diameter, force to penetrate 59.3-62.1 grams/mil thickness; and (ix) strength and stiffness measurements per the following table D.

TABLE D

| | | Machine | Transverse |
|---|---|---|---|
| Property | Test Method | Direction | Direction |
| Tensile strength, psi | ASTM D882 | 332 | 247 |
| Tensile Elongation, % | ASTM D882 | 48 | 20 |
| Matrix Tensile Strength, psi | Gore definition | 1,540 | 1,150 |
| Tensile Modulus, psi | ASTM D882 | 8,360 | — |

This Example had fluid (air and water) flow rates considerably higher than those of any of the referenced patents, evidence of its highly open structure.

### Example 5

A mixture of 97% acetone, 3% polymer (AtoChem PVDF-HFP 2801), 2% water (all amounts by weight %) was heated to about 40° C. with high shear mixing until all the polymer material dissolved. The resulting solution was cooled carefully to about 30° C. to avoid any gel formation. The solution was then coated onto glass or smooth metal foil substrates at ambient temperature to yield about 500 micron of solution film thickness.

The film was further solidified/dried into final configuration by natural convection or forced air drying at a temperature of about 25° C. The dried polymer was removed from the substrate. A low interfacial tension alcohol was used to wet the porous membrane to break adhesion of polymer to glass. The film was further dried prior to use in lithium cells (i.e., vacuum oven drying of solidified films at <50 C. for 16 hr).

The above procedure was repeated to produce microporous polymer films both the PVDF-HFP copolymer material as well as blends thereof with multiple PVDF grades and liquids. These samples were produced as described above using water as the high interfacial tension liquid. The table below provides the details for these samples.

TABLE E
Test Sample Data for Density and Porosity Calculation Formulation

| | | Length | Thickness | | Density | Porosity |
|---|---|---|---|---|---|---|
| Composition | Width (cm.) | (cm.) | (μ) | Weight (g) | (g/m/l) | (%) |
| 3% PVDF 2801; | 12 | 24 | 190 | 0.38 | 0.69 | 85 |
| 2% water; 95% | | | | | | |
| acetone | | | | | | |
| same as above | 15 | 29 | 190 | 0.47 | 0.57 | 90 |
| (except coated on | | | | | | |
| ethylene glycol | | | | | | |
| release agent) | | | | | | |
| 2.3% PVDF 2801, | 13 | 16 | 250 | 0.23 | 0.44 | 87.5 |
| 1.5% PVDF | | | | | | |
| 301F, | | | | | | |
| 0.75% PVDF 761, | | | | | | |
| 78.2% acetone, | | | | | | |
| 6.9% MEK, 6.9% | | | | | | |
| dioxolane, 3.4% | | | | | | |
| water | | | | | | |

### Comparative Example A

A mixture was made according to the teachings of U.S. Pat. No. 5,387,378 using 10% PVDF homopolymer and 2% PVDF-HFP copolymer in a mixture of acetone, 73%, and dimethylformamide, 15%. Portions of the solution were spread with a doctor blade onto a glass substrate (interfacial tension 250-500 dynes/cm) and were allowed to dry at 25° C. for time periods of 1 hour and for 3 hours. After these time periods, the membranes were washed with water. The 3-hour dry sample appeared to be white and opaque, but the 1-hour dry sample was able to be wetted with water and therefore became clear, indicating the presence of residual DMF. The films were then washed with isopropanol.

When the films were fully dry, the 3-hour dry film was too fragile to handle and to measure film thickness with a micrometer. The 1-hour dry film had fair strength, but it was brittle and it had about 40% porosity.

### Comparative Example B

The procedure of Example 1 was repeated to prepare three films using Kynar 2801 (PVDF-HFP copolymer) at 3 to 6% by weight concentrations in acetone as the sole liquid. The acetone-polymer mixture was heated under pressure to 56° C. After cooling to 35° C., each solution was spread onto glass and the acetone removed by drying at 30° C.

Film thickness ranged from 0.5 to 5 mils and void volumes ranged 40 (thickest) to 74% (thinnest). The films strengths were unacceptably weak, ranging from fragile to fair.

### Comparative Example C

Three films were prepared using 3% of three different commercially available PVDF polymers. Two of the polymers were homopolymers and one was a PVDV-HFP copolymer. To the polymers was added 94% acetone and 3% ethanol (b.p. 78 C, interfacial tension 22 dynes/cm).

All of the films were too fragile to test.

### Comparative Example D

Three films were prepared using the three different PVDF polymers of Comparative Example C in three different 3% solutions, 94% acetone and 3% ethylene glycol (b.p. 196° C., interfacial tension 48 dynes/cm). The glycol was removed by extended forced air convection drying at moderate temperature (25° C. going up to 40° C. max) followed by a final water rinse and dry.

Films ranged from 71 to 81% porosity and had good puncture resistance.

The process was feasible, but required a water wash to remove the glycol or a long evaporation time, with emission of toxic vapors.

While the preferred embodiment of the invention has been illustrated and described, as noted above, many changes can be made without departing from the spirit and scope of the invention. For example, various known methods of removing the second liquid without exceeding the melting temperature of the polymer may be exploited without departing from the spirit of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for forming a gelled polymer, the method comprising:
providing a polymer having a known polymer interfacial tension and a known polymer melting point;
providing a first liquid into which the polymer is soluble, the first liquid being selected to have a first liquid interfacial tension to be 95% or less than the polymer interfacial tension;
mixing a second liquid that is miscible in the first liquid to form a mixture, the second liquid being selected to have a second liquid interfacial tension to be 105% or greater than the polymer interfacial tension;
dissolving the polymer into the mixture to form a saturated solution;
causing the saturated solution to reach a solution forming temperature less than the polymer melting point;
forming the saturated solution on a substrate; and
selectively removing the first liquid from the saturated solution to form the gelled polymer.

2. The method of claim 1, wherein:
the polymer is PVDF, having an interfacial tension of about 35 dynes/cm;
the first liquid is selected from a group consisting of methyl formate at about 24.4 dynes/cm, acetone (2-propanone) at about 23.5 dynes/cm, methyl acetate at about 24.7 dynes/cm, tetrahydrofuran at about 26.4 dynes/cm, ethyl acetate at about 23.4 dynes/cm, methyl ethyl ketone (2-butanone) at about 24 dynes/cm, acetonitrile at about 29 dynes/cm, dimethyl carbonate at about 31.9 dynes/cm, 1,2-dioxane at about 32 dynes/cm, toluene at about 28.4 dynes/cm, and methyl isobutyl ketone at about 23.4 dynes/cm;
the second liquid is liquid miscible with the first liquid and selected from a group consisting of nitromethane at about 37 dynes/cm, bromobenzene at about 37 dynes/cm, formic acid at about 38 dynes/cm, pyridine at about 38 dynes/cm, ethylene bromide at about 38 dynes/cm, 3-furaldehyde at about 40 dynes/cm, bromine at about 42 dynes/cm, tribromomethane at about 42 dynes/cm, quinoline at about 43 dynes/cm, nitric acid (69%) at about 43 dynes/cm, and water at about 72.5 dynes/cm;
wherein the solution forming temperature is between 20 and 90° C.; and
and the film forming temperature is selected to be less than 177° C.

3. The method of claim 1 wherein the selectively removing the first liquid includes reducing an ambient pressure around the saturated solution sufficiently to shift a first liquid boiling point.

4. The method of claim 1 wherein the selective removing the first liquid includes heating the saturated solution to reach a removal temperature distinct from the solution forming temperature and less than 177° C.

5. The method of claim 1, wherein the saturated solution is a stable saturated solution.

6. The method of claim 1, wherein the removing the first liquid shifts the saturated solution to a supersaturated solution.

7. The method of claim 1 further including the causing the saturated solution to reach a film forming temperature that is less than the second temperature whereby the polymer gel is formed.

8. The method of claim 1, wherein the removal of the first liquid includes transitioning the saturated solution into a supersaturated solution.

9. The method of claim 1 wherein the removal of the first liquid occurs by one of a group consisting of cooling, forced air drying, extended dwell time, first liquid evaporation, vibration, and ultrasonics.

10. The method of claim 1 further including the removal of the second liquid from the gelled polymer to form a porous membrane, the removal occurring at a second liquid removal temperature less than 100°

11. The method of claim 10, wherein the second liquid removal temperature is less than 80° C.

12. The method of claim 1, wherein the polymer is selected from a group consisting of polyvinylidene fluoride, polyvinylidene fluoridehexafluoropropylene copolymer, polyvinyl chloride, polyvinylidene chloride, chlorinated polyvinyl chloride, polymethyl methacrylate, and mixtures of two or more of these semi-crystalline polymers.
